(19) United States
(12) Patent Application Publication
(10) Pub. No.: US 2011/0178939 A1
(43) Pub. Date: Jul. 21, 2011

(54) SYSTEM AND METHOD FOR DEVELOPING, IMPLEMENTING, AND MONITORING A DYNAMIC SCALABLE PHILANTHROPIC INFRASTRUCTURE THAT MOTIVATES AND EMPOWERS INDIVIDUALS TO ENGAGE IN AND MANAGE DESIRED CUSTOMIZABLE PHILANTHROPIC ACTIVITIES

(75) Inventors: Thom Hamill, New York, NY (US); Carol Davidson, New York, NY (US)

(73) Assignee: WEALTHRIGHT, INC., New York, NY (US)

(21) Appl. No.: 13/010,652

(22) Filed: Jan. 20, 2011

Related U.S. Application Data
(60) Provisional application No. 61/296,499, filed on Jan. 20, 2010.

(51) Int. Cl. G06Q 99/00

(52) U.S. Cl. 705/319

(57) ABSTRACT

The present invention is directed to systems and methods for providing unconventional employee benefit plans and corresponding customizable benefits to high-earning individuals, and more particularly to a system and method for developing, implementing, and monitoring a dynamic scalable philanthropic infrastructure, that is made available to selected members of an implementing organization as a workplace benefit, and that includes at least one or more customizable training and counseling components configured to provide the eligible participating members with a better understanding of philanthropy as part of a balanced lifestyle, and to motivate, empower, and guide the members, to engage in, and to manage one or more desired philanthropic activities.

### CROSS REFERENCE TO RELATED APPLICATIONS

The present patent application claims priority from the commonly assigned co-pending U.S. provisional patent application 61/296,499 entitled “System and Method for Developing, Implementing, and Monitoring a Dynamic Scalable Philanthropic Infrastructure that Motivates and Empowers Individuals to Engage in and Manage Desired Customizable Philanthropic Activities”, filed Jan. 20, 2010.

### FIELD OF THE INVENTION

The present invention relates generally to systems and methods for providing unconventional employee benefit plans and corresponding customizable benefits to high-earning individuals, and more particularly to a system and method for developing, implementing, and monitoring a dynamic scalable philanthropic infrastructure, that is made available to selected members of an implementing organization as a workplace benefit, and that includes at least one or more customizable training and counseling components configured to provide the eligible participating members with a better understanding of philanthropy as part of a balanced lifestyle, and to motivate, empower, and guide the members, to engage in, and to manage one or more desired philanthropic activities.

### BACKGROUND OF THE INVENTION

Traditionally, the practice of “philanthropy” has been the privilege available to very few and very wealthy individuals (and the foundations or other institutions they often form for such purposes), and as a result very few realize the full extent of the benefits of engagement in philanthropic activities, not only for the beneficiaries thereof, but also for the “philanthropists” themselves. However, while the practice of philanthropy is far more than just donating funds to a “worthy cause”, to date, only those in very privileged positions (often as a result of their being born into a philanthropic family), or by way of very specialized education fully understand it, and the issues involved.

With the growing disparity between wealthy individuals and the shrinking middle class, and with individuals employed in certain industries (e.g., financial, etc.), as well as their employers, earning more than ever, there is a great unmet need to provide a way for any well-to-do individuals with a better understanding of philanthropy as part of a balanced lifestyle, and to motivate, empower, and guide the members, to engage in, and to manage one or more desired philanthropic activities.

Accordingly, it would be very advantageous to achieve the above through application of various modular business methodologies, such as working with various organizations (and preferably financial institutions with numerous highly paid employees/members) to provide philanthropic training and related services to their employees/members as a workplace benefit, to enable the employees/members of various participating organizations to communicate with each other regarding their philanthropic activities and related matters, and to enable the participating organizations to gain additional benefits by providing opportunities thereto to advertise their commitment to corporate social responsibility on a wide scale.

### BRIEF DESCRIPTION OF THE DRAWINGS

In the drawings, wherein like reference characters denote corresponding or similar elements throughout the various figures:

FIG. 1 is a schematic diagram of an exemplary embodiment of the inventive Cognitive Philanthropy for a Balanced Lifestyle (CP/BL) Infrastructure;

FIG. 2 is a schematic diagram of an exemplary embodiment of the inventive CP/BL Matrix, illustrating the relevant background factors as well as solution support factors and implementation outcomes for the CP/BL Core Platform/Methodology of the CP/BL Infrastructure of FIG. 1;

FIG. 3 is a process flow diagram showing a first exemplary embodiment of an inventive process for implementing the novel CP/BL Infrastructure of FIG. 1 in a business methodology context;

FIG. 4 is a process flow diagram showing a second exemplary embodiment of an inventive process for implementing the novel CP/BL Infrastructure of FIG. 1 in a business methodology context;

FIG. 5 is a schematic diagram of an exemplary embodiment of an exemplary selection of CP/BL Benefit Plan Configurations/CP/BL Benefit Components that may be advantageously utilized in connection with implementation of the novel processes of FIG. 3 and/or of FIG. 4; and

FIG. 6 is a schematic diagram of an exemplary embodiment of an exemplary CP/BL Benefit Component involving multi-session training/instruction of individuals and/or groups in various aspects of CP/BL Core Platform/Methodologies, for example following the implementation of the processes of FIG. 3 or 4.

### SUMMARY OF THE INVENTION

The present invention is directed to a system and method for developing, implementing, and monitoring a dynamic scalable philanthropic infrastructure, that is made available to selected members of an implementing organization as a workplace benefit, and that includes at least one or more customizable training and counseling components configured to provide the eligible participating members with a better understanding of philanthropy as part of a balanced lifestyle, and to motivate, empower, and guide the members, to engage in, and to manage one or more desired philanthropic activities, as well as to share information relating to their philanthropic activities with fellow members from their own organization, as well as from other participating organizations. In addition, organizations deploying various embodiments of the inventive system and method can receive additional benefits therefrom, such as being able to advertise their commitment to corporate social responsibility to the world at large on a wide scale than was previously possible.

The system and method of the present invention address the challenges of bringing the benefits of engagement in philanthropic activities to a much greater audience than was previously possible, by providing techniques and methodologies for developing, implementing, and monitoring a dynamic scalable philanthropic infrastructure, that, for example, may be made available to selected members of an implementing organization as a workplace benefit, and that includes:
(1) At least one or more customizable training and counseling components configured to provide the eligible participating members with a better understanding of philanthropy as part of a balanced lifestyle, and to motivate, empower, and guide the members, to engage in, and to manage one or more desired philanthropic activities, and (2) At least one or more customizable social networking or equivalent components configured to provide the eligible participating members with means for communicating with other members from their own organization (as well as with members from other participating organizations) on the subjects of their current or planned philanthropic activities.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The various embodiments of the system and method of the present invention (hereinafter interchangeably individually and collectively referred to as the “WealthRight Platform”) address the challenges of bringing the benefits of engagement in philanthropic activities to a .much greater audience than was previously possible, by providing techniques and methodologies for developing, implementing, and monitoring a dynamic scalable philanthropic infrastructure, that, for example, may be made available to selected members of an implementing organization as a workplace benefit, and that includes at least one or more customizable training and counseling components configured to provide the eligible participating members with a better understanding of philanthropy as part of a balanced lifestyle, and to motivate, empower, and guide the members, to engage in, and to manage one or more desired philanthropic activities, and to share information relating to their philanthropic activities with fellow members from their own organization, as well as from other participating organizations. In addition, organizations deploying the WealthRight Platform can receive additional benefits therefrom, such as being able to advertise their commitment to corporate social responsibility to the world at large on a wide scale than was previously possible.

Because philanthropy is not something studied in school or necessarily discussed at home, it has become a ‘hidden’ value except among the elite. As evidenced by the creation of various well-publicized philanthropic challenges by well-known philanthropists, people need to discuss, share ideas, and ask questions about philanthropy. Philanthropic knowledge belongs in the hands of the many, not the few, and the corporate workplace provides the perfect platform for making this shift. Access to increased information/education about philanthropy is not easy to come by, so while many are writing checks both small and large, few are writing them with a sense of comfort, confidence and contentment—even in response to disaster relief.

Never has there been a time when the public perception of a corporation's sense of social responsibility has been keener. It is imperative that intentional education and idea-sharing fills the void left by an increasingly disengaged workforce. Corporations would do well to impress upon their employees, customers and shareholders that corporate leadership values a well balanced and well informed workforce as part and parcel of the successful bottom line.

The WealthRight platform advantageously offers an array of socio-educational opportunities designed to increase employee intelligence around, and engagement with, philanthropy. In at least one embodiment thereof, the WealthRight Platform may be deployed as an employer-provided workplace benefit that also offers corporate subscribers the opportunity to advertise their commitment to Corporate Social Responsibility (CSR) on a wide scale.

The WealthRight Platform is a response to at least three core wide-spread needs:

1. Giving is most robust when ideas and decisions surrounding it are both informed and part of a conversation.

2. Twenty and thirty-somethings in the work place today have not been educated or even exposed to the “ABC's of Philanthropy”.

3. Corporate organizations are under fire for perceived greed and narcissism.

The goals of the WealthRight Platform include, but are not limited to, the following:
To create and expand conversations around philanthropy.
To shine a spotlight on CSR for both internal and external stakeholders.
To make “giving” like eating: “you can't live without it.”

The WealthRight Platform stimulates thinking, empowers individuals and encourages giving by putting philanthropy in the place it deserves and needs to be: up front, not behind the scenes. In doing so, the WealthRight Platform enhances a corporation's value system and links the personal philanthropic efforts of employees with already existing CSR systems in place. The result is:

An enhanced corporate public image where employees and consumers know that giving back and learning/personal development is valued and supported.

A global socio-educational network that connects and inspires vast numbers of individuals and organizations.

The WealthRight Platform allows individuals to grapple with issues large and small, personal and impersonal, psychological and circumstantial. At the broadest level, that grappling may be accomplished through integrated social networking tools that help employees interact and think collaboratively, building a strong workplace community based on value commonality. At the most selective level, that grappling is accomplished through face to face conversations in a variety of formats, seminars and retreats, fostering a shared sense of common struggles and goals. At any level, the key premise remains the same: that it takes work and education to change the relationship most people have with philanthropy and that it is possible to build communities of philanthropists within and across corporations.

While many companies, advisors, services and literature intended to educate individuals about a smart approach to wise philanthropy exist, most are directed at the very wealthy—a “members only” gate keeping mystique prevents the average person from benefiting. The interaction between employee subscribers and the WealthRight Platform will be one that is sensitive to the limited attention span of an increasingly plugged-in workforce. Relevant, exciting and consistent engagement, will challenge assumptions and expand philanthropic thinking.

What makes the WealthRight Platform particularly advantageous is its focus on chipping away at psychological barriers and capitalizing on natural philanthropic instincts. Regardless of a person's age, reaching for a fuller and more satisfying philanthropic life is worth doing. The WealthRight Platform delivery system is not only targeted, it is encouraging and inspiring. The WealthRight Platform takes the fear out of philanthropy, by providing customized tools to assist individuals to understand, define, activate and direct their giving. No other philanthropic information system can claim this benefit.

Advantageously, the WealthRight Platform includes at least the following tools in various embodiments thereof.

Philanthropic Dashboard: a comprehensive picture of what a company is contributing to society, including all public information on charitable gifts made through the corporate foundation, matching gift programs, cause marketing and current volunteer activity, plus information provided anonymously by employees about their own philanthropic activities.

Philanthropic IQ: an individual assessment for eligible employees of current giving, patterns of giving, giving destinations, family involvement, inherited bias and preconceived notions.

Traditional and non-traditional educational media tools.

In addition to offering an important benefit to employees, the WealthRight Platform provides additional advantages to participating organizations:

A company can choose to publically acknowledge their participation in the WealthRight. Platform network, and demonstrate this in all public relations materials.

The WealthRight Platform is operable to offer an anonymous employee philanthropic data capture option so that companies can create and report a first ever comprehensive “baseline giving index” and build on this from year to year.

By raising the visibility of personal philanthropic activity within a company, employees will become more engaged with the corporate foundation and corporate matching gift program.

The WealthRight Platform may generate revenue streams through a variety of means. In various embodiments thereof the WealthRight Platform is at least in part implemented in various participating organizations as a workplace benefit free of charge to employees. Each participating organization then pays a periodic (e.g., monthly) subscription fee based on a predetermined formula (e.g., taking into account the size of the organization and number of eligible employees). The WealthRight Platform is also operable to provide a highly desirable advertising platform for corporate members and not-for-profit organizations.

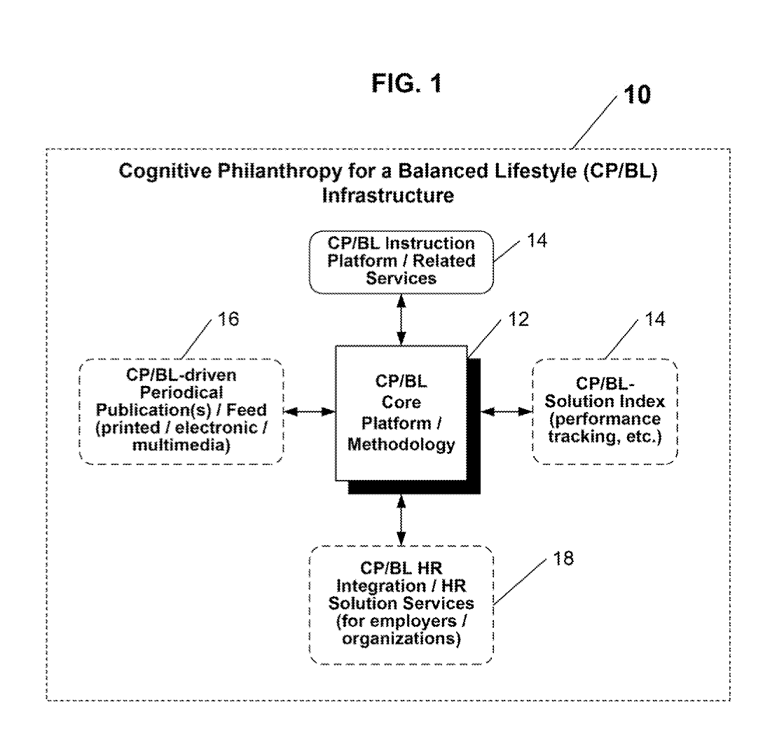

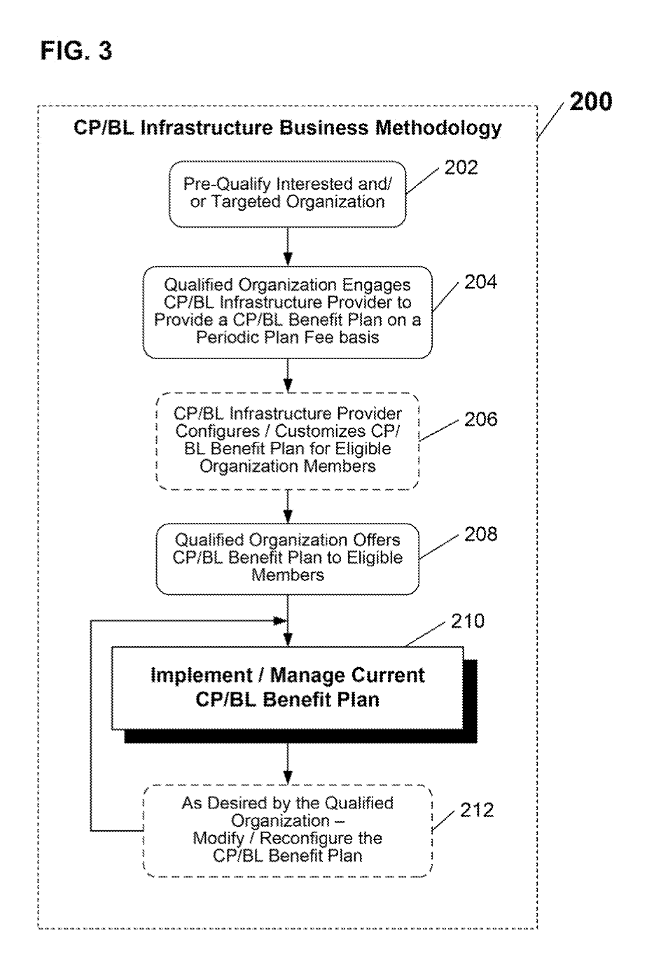

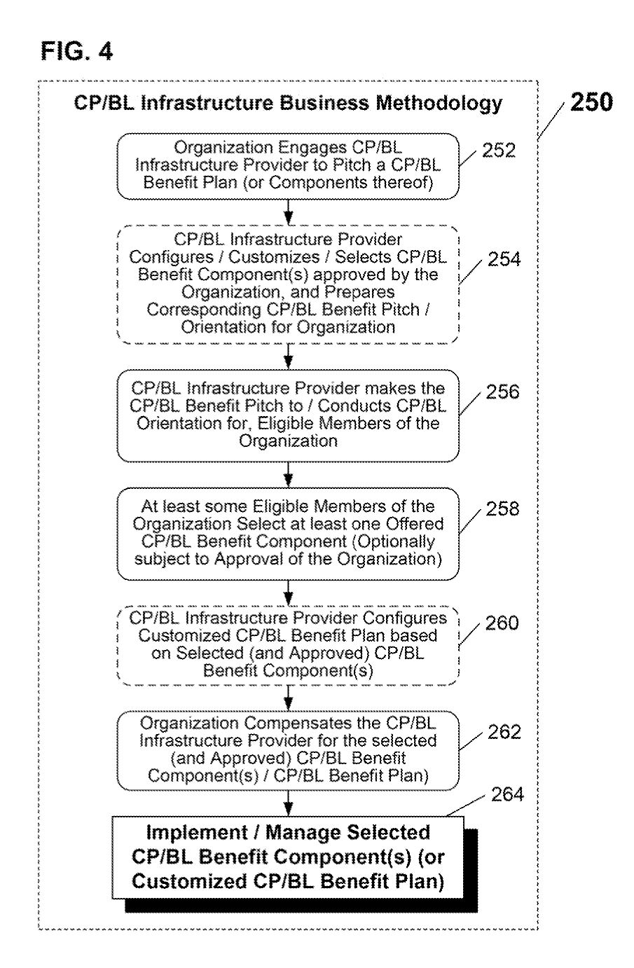

Referring now to FIG. 1, a schematic diagram is shown of an exemplary embodiment of an implementation of the WealthRight Platform illustrated as an inventive Cognitive Philanthropy for a Balanced Lifestyle (CP/BL) Infrastructure 10, which is based on CP/BL Core Platform/Methodology 12, that comprises various proprietary techniques and methodologies for implementing philanthropy-related business, training, HR, and other solutions and offerings through one or more business methodologies (such as shown by way of example in FIGS. 3 and 4), and which may comprises various support components such as CP/BL Instruction Platform/Related Services component, as well as one or more other components, which may include, but which are not limited to: CP/BL-Solution Index (performance tracking, etc.), CP/BL-driven Periodical Publication(s)/Feed (printed/electronic/multimedia), and CP/BL HR Integration/HR Solution Services (for employers/organizations).

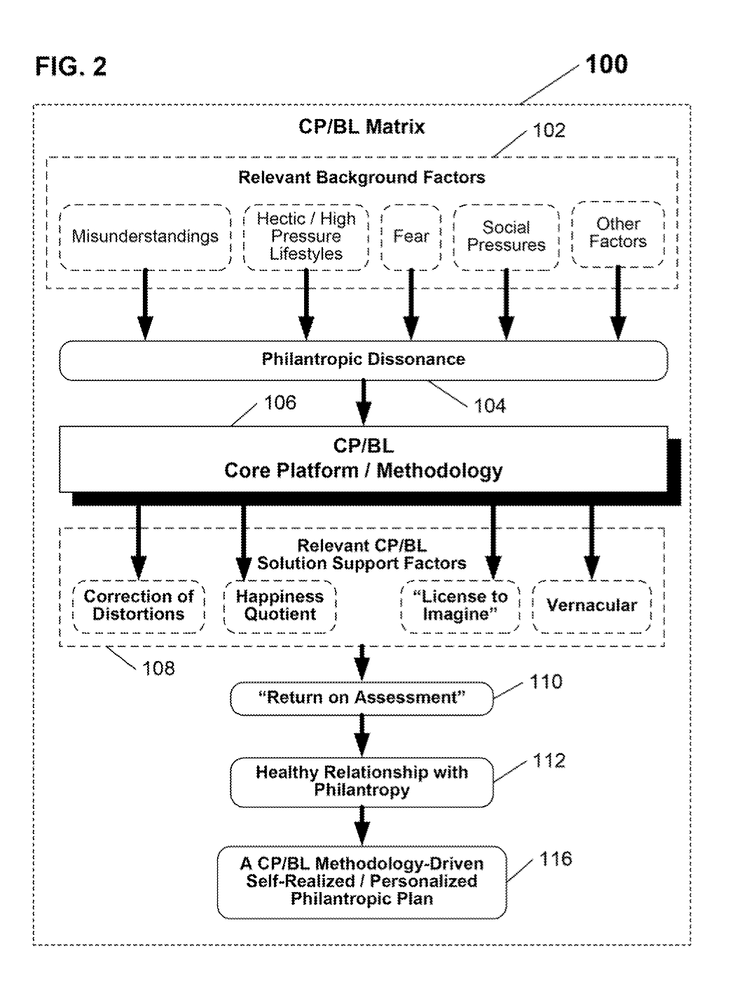

Referring now to FIG. 2, a schematic diagram is shown of an exemplary embodiment of an inventive CP/BL Matrix 100, illustrating exemplary relevant background factors 102 leading to philanthropic dissonance 104 that creates the void filled by implementation and utilization of the novel CP/BL Core Platform/Methodology 106. The CP/BL Matrix 100 also includes exemplary relevant CP/BL solution support factors 108 and implementation outcomes for the CP/BL Core Platform/Methodology of the CP/BL Infrastructure of FIG. 1 (e.g., a “Return on Assessment” 110, a Healthy Relationship with Philanthropy, 112, and a CP/BL Methodology-Driven Self-Realized/Personalized Philanthropic Plan 116)

Referring now to FIG. 3, a process flow diagram is shown of a first exemplary embodiment of an inventive CP/BL Infrastructure Business Methodology process 200, comprising preferred steps 202, 204, 208, and 210, and optional steps 206, 212, for implementing the novel CP/BL Infrastructure of FIG. 1 in a context of offering benefits, and other HR and PR related services, to various organizations.

Referring now to FIG. 4, a process flow diagram is shown of a second exemplary embodiment of . an inventive CP/BL Infrastructure Business Methodology process 250, comprising preferred steps 252, 256, 258, 262 and 264, and optional steps 254, 260, for implementing the novel CP/BL Infrastructure of FIG. 1 in a context of offering benefits, and other HR and PR related services, to various organizations.

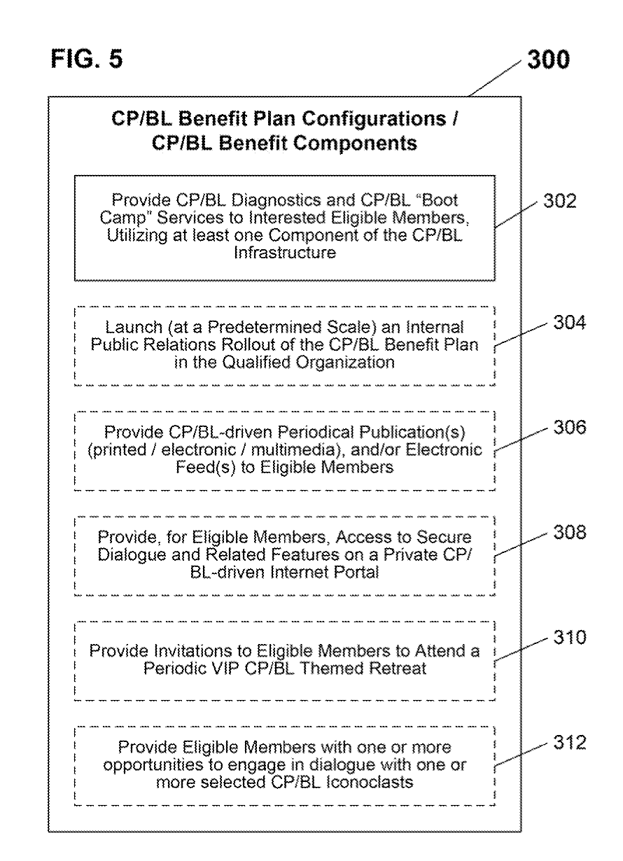

Referring now to FIG. 5, a schematic diagram is shown of an exemplary embodiment of an exemplary selection of CP/BL Benefit Plan Configurations/CP/BL Benefit Components selection 300 that may be advantageously utilized in connection with implementation of the novel process 200 of FIG. 3 and/or the novel process 250 of FIG. 4, which preferably comprises at least one core component 302, and which may additionally comprise one or more of the additional optional components 304 to 312.

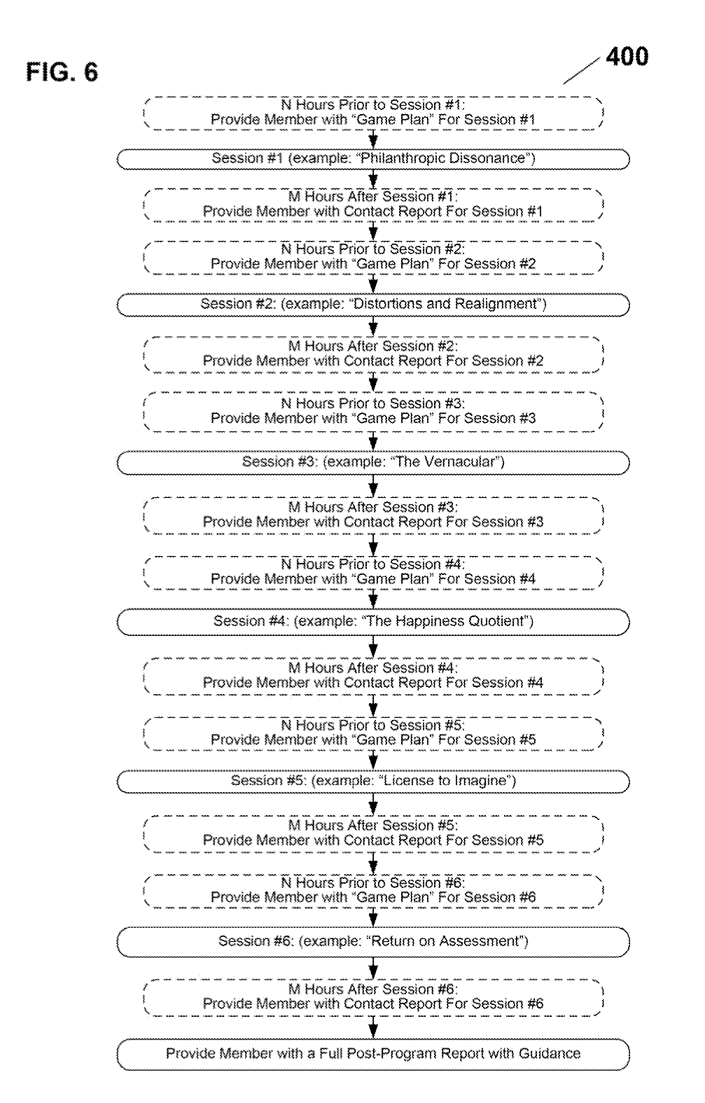

Finally, referring now to FIG. 6, a schematic diagram is shown of an exemplary embodiment of an exemplary CP/BL Benefit Component 400 involving multi-session training/instruction of individuals and/or groups in various aspects of CP/BL Core Platform/Methodologies (preferably utilized in connection with deployment of the component 302 of FIG. 5, or equivalent thereof), for example following the implementation of the process 200 of FIGS. 3, or the process 250 of FIG. 4.

Thus, while there have been shown and described and pointed out fundamental novel features of the inventive system and method as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A method, at least in part implemented in a data processing system connected to a communication network, for developing, implementing, and monitoring a dynamic scalable philanthropic infrastructure, comprising the steps of:
(a) providing a membership-based modular dynamic scalable philanthropic infrastructure and platform, at least partially implemented in a data processing system accessible through at least one communication network, that is operable to provide members thereof with a better understanding of philanthropy as part of a balanced lifestyle, to motivate, empower, and guide the members, to engage in, and to manage one or more desired philanthropic activities, and to enable members to communicate with one another and to share information relating to philanthropic issues and activities therebetween; and
(b) offering membership access to said modular dynamic scalable philanthropic infrastructure and platform to a plurality of organizations, as a workplace benefit that may selectively be made available by at least one participating plural organization to at least a portion of employees thereof.
